(19) United States
(12) Patent Application Publication
(10) Pub. No.: US 2002/0121986 A1
(43) Pub. Date: Sep. 5, 2002

(54) Method and system for identifying an object and announcing a voice message

(76) Inventors: William Krukowski, Nahariya (IL); Roman Roitblat, Haifa (IL); Michael Fridhendler, Nahariya (IL)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/067,504

(22) Filed: Feb. 7, 2002

(30) Foreign Application Priority Data
Feb. 7, 2001 (IL) 141299

(51) Int. Cl. H04Q 1/00

(52) U.S. Cl. 340/825.19

(57) ABSTRACT

Method and associate System for identification of an object and announcing a voice message, are disclosed. Said method, and the system using the method are especially usefull for assisting blind people in identifying objects. The method is comprised of tie steps of attaching a code or a label with code—written or printed code such as barcode, color-code, RFID tag or any other code—on any object intended to be identified, or alternatively, using an existing code or label on the object, each object has its particular code; storing a voice-message, with accordance to each code, in a memory; using a reader or a sensor to read or sense said attached code from said object; obtaining from the memory, the match voice-message according to said code; and announcing said voice-message

The system, is comprised of a label, a sensor or a reader capable of reading the label, a memory containing a table of codes and voice-messages, an amplifier with a speaker to announce said voice-message, and a microprocessor or microcontroller for coordinating the reciprocal operation of the other system components.

### FIELD OF THE INVENTION

The present invention relates to the field of accessories that help blind people and seeing impaired people. More specifically, the present invention relates to a method and a system for identifying an object and announcing a voice-message, usually the identification details. The present invention is useful for peoples and systems, will hereinafter “seeing impaired users”such as blind peoples, seeing (visual) impaired peoples and application systems for use in a situation when visual identification is difficult or impossible.

### BACKGROUND OF THE INVENTION

Objects are identified through various parameters, e.g. shape, color and size. It is common practice to identify produced objects and even personal objects by information that is written on the object or on a label that attached to the object. Therefore, there are many objects with the same size and shape and differ only by a written information on the object itself. Identification of such objects, by seeing impaired users, is very difficult.

Several methods and systems for identifying objects, e.g. products and documents, are known. One of the spread systems is the “barcode” system, which is used in selling points and in storing areas. Other method system is the RFID. In this system, the sensor transmits RF energy to a label that contains an antenna, electrical circuit and transponder. The antenna receives the transmitted energy, stimulates the electrical circuit and the electrical circuit transmits an identify information back to the sensor.

The main disadvantage of the known systems is that the identified information is displayed on displaying devices and these systems are useless for blind people and seeing impaired users.

There is therefore a recognized need for, and it would be highly advantageous to have, a method and a system for identification an object and announce the identification detail, that is more effective and reliable—for seeing impaired users—then systems known heretofore.

### SUMMARY OF THE INVENTION

The present invention is a method and a system for identification an object and announcing a voice-message, possibly the identification of the identified object.

According to the teachings of the present invention there is provided a method for identification of an object and announcing a voice-message, including the following steps:

(a) attaching a code or a label with code—written or printed code such as barcode, color-code, RFID tag or any other code—on at least one object, wherein each code is different; or

(b) using an existing code or label on the object;

(c) storing a voice-message, with accordance to each code, in a memory;

(d)using a reader or a sensor to read or sense the code from the label;

(e) obtaining from the memory, the match voice-message according to the code; and

(f) announcing the voice-message.

It will be noted, however, that the alphabetic characters used to designate the steps are provided for convenience only and do not imply any particular order of performing the steps.

In another aspect of the method of the present invention, in step (c) of the method, a code is sensed or read and in step (d) a voice-message is recorded, then in step (e) storing the voice-message and the code with accordance.

According to yet another aspect of the present invention there is provided a system for identification of an object and announcing a voice-message, including (a) at least one label containing a code, for attaching it to an object, (b) a sensor or a reader to sense or read the code from a label, (c) a memory that contains voice-messages, each voice-message is stored with accordance to a specific code, (d) an amplifier with a speaker to announce the voice-message, and (d) a microprocessor operative for (i) receiving a sensed or a read code from the reader or from the sensor, (ii) obtaining from the memory, a suitable voice-message according to the received code; and (iii) using the amplifier and the speaker to announce the voice-message.

According to yet another aspect of the present invention there is provided an identification system wherein the system is further includes a recording unit, this recording unit includes a microphone for recording voice messages.

According to further features in the described preferred embodiment, the system has two working modes, an “identifying mode” for identifying and announcing a voice-message and “learning mode” for recording and storing voice-messages. The system can be change to a learning mode and the microprocessor is further operative for (i) receiving a sensed or a read code from the reader or from the sensor, (ii) checking in the memory if the read code is existing, (iii) if the read code is existing announcing the correspondence message, otherwise sounding a special sound or special message through the voice unit, (iv) according to a user command, receiving a recorded voice-message, which is recorded by the user, from the recording unit, and (V) storing the recorded voice-message with accordance to tie code in a memory or replacing the previous message by the new recorded message.

According to one of the preferred embodiment the sensor is a barcode reader and the attached code is a barcode.

According to other preferred embodiment the sensor is a color sensor and the attached code is a color-code.

According to other preferred embodiment the reader is a sweeping scanner and the attached code label has rails or borders to guide the scanning along the code.

According to other preferred embodiment the system has the capability to read uploaded codes, pre-matched with “Text to Speech” sentences to announce them by voice when the system reads one of the codes.

According to other preferred embodiment the sensor is a RFID sensor and the attached code is a tag of RFID) code.

According to other preferred embodiment the accessory has a communication capability to communicate with other devices and to transfer information into and from other devices.

### BRIEF DESCRIPTION OF THE FIGURES

In the drawing:

FIG. 1 is an illustration of the system for identifying and announcing, showing the embodiment with a recording unit.

FIG. 2 is a block diagram of the preferred embodiment that illustrated in FIG. 1.

### DESCRIPTION OF THE PREFERRED EMBODIMENTS

The present invention is a method and a system for identification an object and announcing a voice-message, possibly the identification of the identified object.

The principles and operation of the identification system according to the present invention may be better understood with reference to the drawing and the accompanying description.

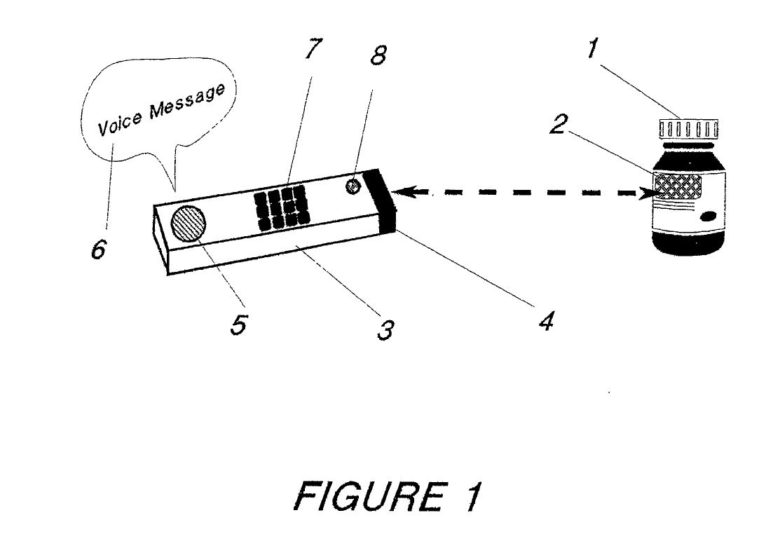

Reference is first being made to FIG. 1 in which the identification system is illustrated. The object 1 is an object with common use shape and the identify details are written on the object 1, but this way of description is useless for blind people and seeing impaired users. To enable seeing impaired user identifying the object, a label 2 with a code on it or a RFID tag is attached to the object 1. A seeing impaired user uses the accessory 3 to identify the object 1. A sensor 4 of the accessory senses the code, which is on the label 2 that attached to the object 1. The accessory 3 finds in a memory (not shown) a voice-message that matches the read or sensed code and the voice-message 6 is announced through a speaker 5. Usually, the announced voice-massage 6 includes identification details and/or other information. If there is no message that matches the code a special message or signal is announced. In such a case, the user can record a message, through the microphone 8, to be stored in accordance with the sensed code in the memory (not shown). The user can record a new message and replace the existing message by using a keyboard. 7 command.

In another embodiment the accessory has two modes of work, an “identification mode” to identify codes that exist in memory and a “learning mode” to record new messages. In case of new object, the seeing impaired user uses other way to identify the object 1, e.g. by an help of other person, then the accessory being change to a learning mode, by using a keyboard 7. The user attaches a new code or a new label 2 with a new code to the object 1 or uses an existing code and then the user uses the sensor 4 to sense the new code and a recording unit to records a new voice-message via the microphone 8. By using the keyboard 7, the user stores the new code with the new message in the memory. In the same manner the user can replace previous message by a new one.

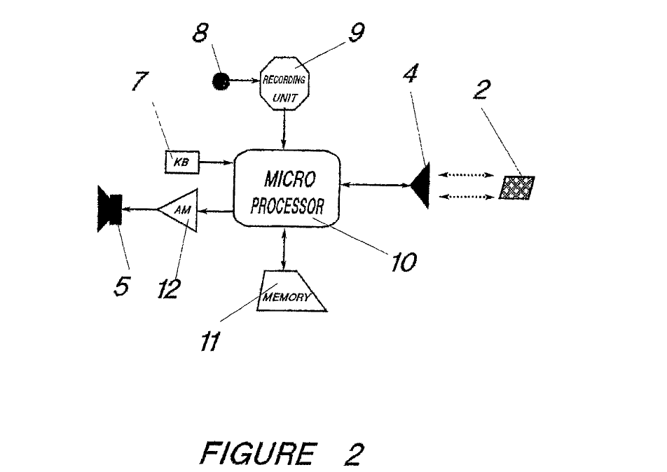

Further attention is now directed also to FIG. 2 in which a block diagram of the system is described. A label 2 or RFID tag with a different code is attached to an object to enable identification. The sensor 4, which can be a barcode reader, color-code reader, RFID sensor or any other sensor, sense or read the code from the label 2. The code is transferred to a microprocessor 10 that search in a memory to find a suitable voice-message. The microprocessor 10 transfers the found voice-message to an amplifier 12, which announces the voice-message through a speaker 5. The system has a keyboard 7, which uses—inter alia—for changing the system to an “identifying mode” or to a “learning mode” and for storing new messages.

To store a new object identification, the system changes to a learning mode using the keyboard 7. A new code is attached to the new object and then sensing the new code and recording a new voice-message, using the recording unit 9 and through the microphone 8. The new code and the new voice-message are stored in the memory with accordance, by a keyboard 7 command.

Although the invention has been described in conjunction with specific embodiments thereof, it is evident that many alternatives, modifications and variations will be apparent to those skill in the art, accordingly, it is intended to embrace all such alternatives, modifications and variations that fall within the spirit and broad scope of the appended claims.

What is claimed is:

1. A method for identification of an object and announcing a voice message, comprising:
(a) attaching a code or a label with code—written or printed code such as barcode, color-code, RFID tag or any other code—on at least one object, wherein each code is different; or
(b) using an existing code or label on the object;
(c) storing a voice-message, with accordance to each code, in a memory;
(d)using a reader or a sensor to read or sense said attached code from said object;
(e) obtaining from the memory, the match voice-message according to said code; and
(f) announcing said voice-message.

2. The method of claim 1 wherein steps (c) and (d) are;
(c) using a reader or a sensor to read or sense said attached code from said object;
(d) recording a voice message;
(d1) storing said voice-message and said code with accordance, in a memory.

3. The method of claim 1 wherein said code is written code.

4. The method of claim 1 wherein said code is color code.

5. The method of claim 1 wherein said code is a tag of RFID.

6. A system for identification of an object and announcing a voice message, comprising:
(a) at least one label containing a code, said label is for attaching to an object;
(b) a sensor or a reader to sense or read an existing code or said code from said label;
(c) a memory contains a table of codes and voice-messages, each of said voice-messages is stored with accordance to a specific code;
(d) an amplifier with a speaker to announce said voice-message; and
(d) a microprocessor operative for:
(i) receiving a sensed or a read code from said reader or said sensor;
(ii) obtaining from said memory, a suitable voice-message according to said received code; and
(iii) using said amplifier and said speaker to announce said voice-message.

7. The system of claim 6, further including a capability to read uploaded codes, pre-matched with “Text to Speech” sentences and said sentences will announce by voice when said code is sensed.

8. The system of claim 6, wherein said code is a barcode.

9. The system of claim 6, wherein said code is a color-code.

10. The system of claim 6, wherein said sensor is a RFID sensor and said code is a tag of RFID.

11. The system of claim 6, further comprising a recording unit and a microphone.

12. The system of claim 11, having at least two working modes, an “identifying-mode” for identifying an object and announcing a voice-message and “learning-mode” for recording and storing voice-messages.

13. The system of claim 12 wherein, while the system is working in said learning-mode, said microprocessor is further operative for:
(i) receiving a sensed or a read code from said reader or from said sensor;
(ii) checking in said memory if said read code is existing;
(iii) if said read code is existing announcing the correspondence message, otherwise sounding a special sound or a special message through said voice unit;
(iv) according to a user command, use said recording unit to record a new voice-message and receiving said new recorded voice-message from said recording unit; and
(v) storing said new recorded voice-message with accordance to said code in said memory or replacing the previous voice-message by said new recorded voice-message.

14. The system of claim 13, wherein said code is a barcode.

15. The system of claim 13, wherein said code is a color-code.

16. The system of claim 13, wherein said sensor is a RFID sensor and said code is a tag of RFID.

17. The system of claim 6, wherein said reader is a sweeping scanner and said label has rails or borders to guide the scanning.

18. The system of claim 13, wherein said reader is a sweeping scanner and said label has rails or borders to guide the scanning.

19. The system of claim 6, further comprising a communication capability for receiving and transferring information to and from other systems.
